(19) United States
(12) Patent Application Publication
(10) Pub. No.: US 2014/0240497 A1
(43) Pub. Date: Aug. 28, 2014

(54) Constellation of Surveillance Satellites

(71) Applicant: Mordechai Shefer, Tel Aviv (IL)

(72) Inventor: Mordechai Shefer, Tel Aviv (IL)

(21) Appl. No.: 13/922,309

(22) Filed: Jun. 20, 2013

Related U.S. Application Data
(60) Provisional application No. 61/662,386, filed on Jun. 21, 2012.

(51) Int. Cl. B64G 1/10; H04N 7/18

(52) U.S. Cl. CPC B64G 1/1085; H04N 7/181; B64G 2001/1028
USPC 348/144; 244/158.4

(57) ABSTRACT

A satellite constellation includes a plurality of satellites in respective polar orbits. The orbits are spaced evenly in longitude and the satellites of adjacent orbits are spaced evenly in latitude. On board each satellite is one or more sensors for monitoring activity within the satellite's field of view.

This patent application claims priority from U.S. Provisional Patent Application No. 61/662,386, filed Jun. 21, 2012

### FIELD AND BACKGROUND OF THE INVENTION

The present invention relates to a constellation of surveillance satellites for monitoring activity on and above the surface of a planet and, more particularly, to a constellation of satellites in polar orbits, such that satellites in adjacent orbits monitor such activity between their orbits stereoscopically. The primary intended application of such a constellation orbiting the Earth is to detecting the launching of ballistic missiles and to tracking the missiles subsequent to their launch.

The most pressing need addressed by the present invention is to detect and continuously track ballistic missiles from their moment of launch up to their reentry, which task is commonly referred to as “From Birth to Death” detection and tracking. The prior art on the subject-matter includes activities such as Northrop-Grumman research described in an online article entitled, “STSS Satellites Demonstrate ‘Holy Grail’ of Missile Tracking” (see Appendix no. 1). In this research project, two Space Tracking and Surveillance System satellites tracked an ARAV-B ballistic missile from launch to splashdown.

### SUMMARY OF THE INVENTION

According to the present invention there is provided a satellite constellation including a plurality of satellites in respective substantially polar orbits around a planet, the orbits being substantially evenly spaced longitudinally, the satellites being substantially evenly spaced latitudinally, each satellite bearing at least one sensor for monitoring activity within a field of view, of a surface of the planet, of the each satellite.

According to the present invention there is provided a method of monitoring activity on the surface of a planet, including the steps of: (a) launching a plurality of satellites into respective substantially polar orbits, the orbits being substantially evenly spaced longitudinally; (b) maintaining a substantially even latitudinal spacing of the satellites; and (c) by each satellite: monitoring activity within a field of view, of a surface of the planet, of the each satellite.

### BRIEF DESCRIPTION OF THE DRAWINGS

Various embodiments are herein described, by way of example only, with reference to the accompanying drawings, wherein:

FIG. 1 shows the line of sight to the horizon from a satellite at an altitude of 350 Km;

FIG. 2 shows a constellation of such satellites in circular polar orbits.

### DESCRIPTION OF THE PREFERRED EMBODIMENTS

The principles and operation of a constellation of surveillance satellites according to the present invention may be better understood with reference to the drawings and the accompanying description.

Although the scope of the present invention extends to monitoring planetary surface activity generally, the primary intended application of the present invention is to monitoring activity on and above the surface of the Earth.

The present invention takes advantage of the rotation of the Earth beneath the constellation of the present invention in order to minimize the number of low-earth-orbit satellites needed to provide continuous stereo data on the locations of all ballistic threats inside a given size volume that surrounds a given threatened location on the earth's surface. It is assumed herein that each satellite of the constellation carries an omnidirectional electro-optical sensor with a given acquisition range. As an example only and without any loss of generality, the preferred example of the present invention that is described herein is of a constellation of satellites in polar orbit at an altitude of 350 Km.

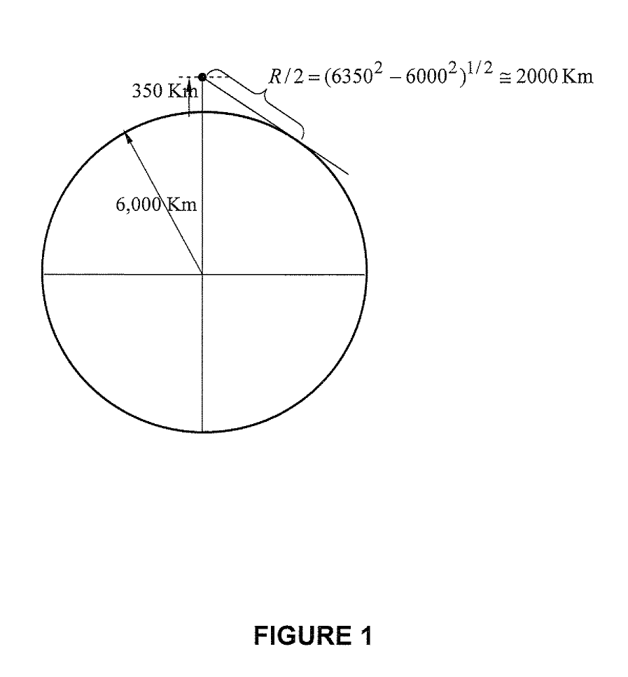

Referring now to the drawings, FIG. 1 shows that the line of sight from a satellite at an altitude of 350 Km to the horizon is approximately 2000 Km. An omnidirectional sensor mounted on this satellite has a conical field of view, of the surface of the Earth and of the region above the surface of the Earth, that is defined by these lines of sight. The overlapping fields of view of two such satellites in adjacent polar orbits provide stereoscopic coverage of activity of interest, such as the launching of ballistic missiles, within the region of overlap.

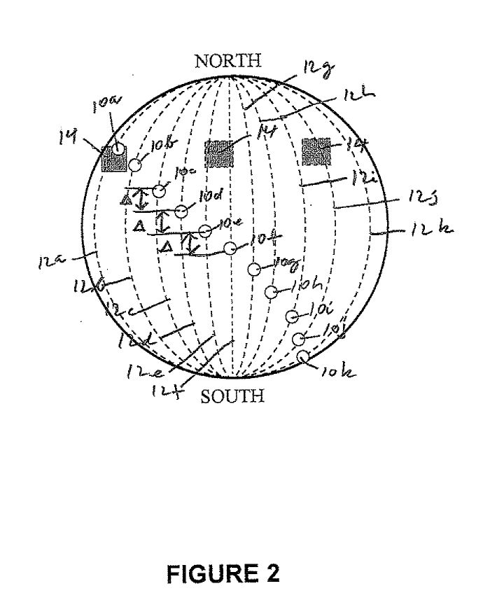

To minimize the number of satellites needed to provide a sufficiently continuous time-continuous location (CTCL) stereo data relevant to a given threatened zone on the surface of the Earth, all satellites are placed in circular polar orbits, as shown in FIG. 2 that shows a constellation of eleven satellites 10a through 10k in respective polar orbits 12a through 12k around the Earth. The phases of satellites 10 are evenly staggered relative to each other by latitudinal ˜38° which amounts to ˜4000 Km, denoted by Δ in FIG. 2. Additionally the orbits of satellites 10 of adjacent orbits 12 are separated in longitude by a common separation which amounts to ˜270 Km on the equator. This feature of the present invention is recited in the appended claims as an “even latitudinal and longitudinal spacing” of satellites 10. Additionally, the total number of satellites 10 in the constellation and their spread out longitudinal inter-space, combined with the evenly staggered phase of latitudinal ˜38° (˜4000 Km) is such that at any given time there are at least two satellites close enough to a threatened zone 14 so that CTCL stereo data on all threats inside an ˜4,000 Km radius field of view surrounding that threatened zone 14 is acquired. In the present 350 Km altitude, 4,000 Km acquisition range example, the velocity of each satellite 10 is 7.69 Km/sec., so that the orbit period of each satellite 10 is 1.52 hours. In an exemplary embodiment, to obtain CTCL stereo data we place satellites 10 ˜4,000 Km apart latitudinally (Δ≈38°⁾ This implies that another satellite 10 passes over a threatened zone 14 every 8.67 minuets. This in turn implies that the constellation of this example includes 83 satellites 10. The distance between the points at which adjacent orbits 12 cross the equator is ˜270 Km in the present example. Fine tuning of the constellation altitude and of both the latitudinal spacing Δ and the longitudinal spacing is done, using thrusters on satellites 12, as is known in the art, in order to synchronize a specific threatened zone 14 to the constellation front in both the south-to-north passage of the constellation and the north-to south passage of the constellation. Once this has been done, several tens of zones 14 can be covered by the same GBATS constellation.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A satellite constellation comprising a plurality of satellites in respective substantially polar orbits around a planet, said orbits being substantially evenly spaced longitudinally, said satellites being substantially evenly spaced latitudinally, each satellite bearing at least one sensor for monitoring activity within a field of view, of a surface of said planet, of said each satellite.

2. A method of monitoring activity on the surface of a planet, comprising the steps of:
(a) launching a plurality of satellites into respective substantially polar orbits, said orbits being substantially evenly spaced longitudinally;
(b) maintaining a substantially even latitudinal spacing of said satellites; and
(c) by each satellite: monitoring activity within a field of view, of a surface of said planet, of said each satellite.
